(19) United States
(12) Patent Application Publication
(10) Pub. No.: US 2026/0244742 A1
(43) Pub. Date: Aug. 20, 2026

(54) CROSS-PLATFORM COMMUNICATION IN SECURITY ORCHESTRATION, AUTOMATION, AND RESPONSE (SOAR) SYSTEMS

(71) Applicant: Cisco Technology, Inc., San Jose, CA (US)

(72) Inventors: Dhananjay Sampath, Sunnyvale, CA (US); Arjun Sambamoorthy, San Jose, CA (US); Prashanth Arun, San Jose, CA (US); Anand Raghavan, Santa Clara, CA (US)

(21) Appl. No.: 19/082,094

(22) Filed: Mar. 17, 2025

Related U.S. Application Data
(60) Provisional application No. 63/761,112, filed on Feb. 20, 2025.

(51) Int. Cl. G06F 21/55

(52) U.S. Cl. CPC G06F 21/554; G06F 2221/034

(57) ABSTRACT

This disclosure describes techniques for facilitating communications between users associated with a Security Orchestration, Automation and Response (SOAR) system using a communication platform that is not native to the SOAR system. In some cases, a system is configured to receive a communication provided by a user profile to a communication interface of the native communication platform, determine that the communication interface is associated with a plurality of user profiles, determine that the one of the plurality of user profiles is associated with the external communication platform, retrieve a set of cross-platform conversion rules for converting communications originating in the native communication platform into communications posted to the external communication platform, determine converted communication data based on the retrieved cross-platform conversion rule(s) and the received communication, and transmit the converted communication to the external communication platform.

### CROSS-REFERENCES TO RELATED APPLICATION(S)

The present application claims priority to U.S. Provisional Patent Application No. 63/761,112, entitled “Cross-Platform Communication in Security Orchestration, Automation, and Response (SOAR) Systems” and filed on Feb. 20, 2025, which is incorporated by reference herein in its entirety and for all purposes.

### TECHNICAL FIELD

The present disclosure relates generally to Security Orchestration, Automation, and Response (SOAR) Systems, and more specifically to cross-platform communication in SOAR systems.

### BACKGROUND

The increasing complexity of information technology (IT) environments and the increasing number of security alerts pose significant challenges for security teams. Security Orchestration, Automation and Response (SOAR) systems have emerged to help address these challenges by automating security operations, streamlining incident response, and improving collaboration among security analysts. Effective communication and collaboration are essential for security teams to respond quickly and efficiently to security threats. However, existing SOAR systems often lack flexible and effective communication capabilities that can facilitate real-time participation of interested parties during critical periods.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 provides an example architecture for enabling a user of a Security Orchestration, Automation, and Response (SOAR) system to communicate with a native communication platform using an external communication platform.

FIG. 2 provides an example user interface of a native communication platform of a SOAR system.

FIG. 3 provides an example user interface of an external communication platform.

FIG. 4 is a flowchart diagram of an example process for generating a converted communication based on a reaction communication.

FIG. 5 is a flowchart diagram of an example process for generating a converted communication based on a communication associated with a file.

FIG. 6 is a flowchart diagram of an example process for transmitting a communication from a native communication platform of a SOAR system to an external communication platform.

FIG. 7 is a flowchart diagram of an example process for predictively generating a communication for posting a native communication platform of a SOAR system.

FIG. 8 shows an example computer architecture for a computer capable of executing program components for implementing the functionality described above.

### DESCRIPTION OF EXAMPLE EMBODIMENTS

### Overview

This disclosure describes techniques for facilitating communications between a set of users associated with a Security Orchestration, Automation and Response (SOAR) system using a communication platform that is not native to (e.g., that is not integrated with) the SOAR system.

In some cases, an example method includes receiving a first communication provided by a first user profile to a communication interface of a first communication platform, the first communication platform being native to a Security Orchestration, Automation and Response (SOAR) system. The method further includes determining that the communication interface is associated with a plurality of users comprising the first user profile and a second user profile. The method further includes determining that the second user profile is associated with a third user profile, the third user profile being associated with a second communication platform. The method further includes retrieving one or more cross-platform conversion rules associated with the second communication platform. The method further includes determining, based on the first communication and the one or more cross-platform conversion rules, a converted communication. The method further includes transmitting the converted communication to a system, wherein the system is configured to, based on receiving the converted communication, display a second communication to the third user profile using the second communication platform.

### Example Embodiments

This disclosure describes techniques for facilitating communications between a set of users associated with a Security Orchestration, Automation and Response (SOAR) system using a communication platform that is not native to (e.g., that is not integrated with) the SOAR system (referred to herein as an “external communication platform”). In some cases, the techniques described herein enable a user associated with a SOAR system to communicate (e.g., to bidirectionally communicate) using an external communication platform. For example, in some cases, the SOAR system may be associated with a native communication platform (e.g., a Webex® communications platform) and may enable a set of users to access a communication interface (e.g., a Webex® space), but may nevertheless enable a user of the SOAR system to communicate with the communication interface hosted on the native communication platform using another external communication platform (e.g., a Microsoft Teams® communication platform).

In some cases, a SOAR system is a system that is configured to facilitate the automation of security operations related to one or more computing environments (e.g., one or more computer systems, one or more computer networks, one or more software applications, and/or the like). For example, a SOAR system may be configured to: (i) receive security alerts from one or more security tools, (ii) aggregate and correlate the security alerts, (iii) automatically execute security playbooks in response to the security alerts, (iv) provide a UI for managing security incidents, (v) generate reports on security incidents, and/or (vi) provide a communication platform for security analysts to collaborate on security incidents. In some cases, a SOAR system integrates with one or more of: (i) a threat intelligence platform for aggregating and processing threat intelligence data, (ii) a security information and event management (SIEM) system for collecting and processing security logs, (iii) a vulnerability scanner for identifying security vulnerabilities, (iv) an endpoint detection and response (EDR) system for detecting and responding to security threats on endpoints, (v) a network security monitoring (NSM) system for detecting and responding to security threats on a network, (vi) a case management system for managing security incidents, (vii) a workflow engine for automating security playbooks, and/or (viii) a reporting engine for generating reports on security incidents.

In some cases, it is advantageous for a SOAR system to have a native communication platform because a native communication platform may: (i) enable security analysts to collaborate on security incidents in real-time, (ii) provide a centralized location for security analysts to discuss security incidents, (iii) enable security analysts to share information about security incidents, (iv) enable security analysts to escalate security incidents to other security analysts, (v) provide a record of security incident communications, and/or (vi) enable security analysts to automate security operations by interacting with the communication platform.

In some cases, a communication platform is a software application and/or a computer system executing operations associated with a software application that facilitates communication between two or more users. For example, a communication platform may be a software application that enables users to exchange messages, files, and other data. As another example, a communication platform may be a computer system that hosts a website that enables users to communicate with each other. In some cases, a communication platform includes a communication interface. A communication interface may be a user interface (UI) or a set of application programming interfaces (APIs) that enable a user and/or a software application to interact with the communication platform. For example, a communication interface may include one or more graphical user interface (GUI) elements that enable a user to compose and send messages, view received messages, and manage communication channels. As another example, a communication interface may include one or more APIs that enable a software application to retrieve messages, send messages, and manage user profiles. In some cases, a communication platform enables a set of users to perform one or more communication-related actions. For example, a communication platform may enable a user to: (i) send a message to another user, (ii) receive a message from another user, (iii) create a group of users, (iv) add a user to a group, (v) remove a user from a group, (vi) send a message to a group, (vii) receive a message from a group, (viii) react to a message, (ix) create a hierarchical message thread, (x) reply to a message, (xi) create a page, (xii) edit a page, (xiii) share a page, (xiv) initiate an audio and/or video conference, and/or (xv) join an audio and/or video conference.

In some cases, a “native communication platform” is a communication platform that is native to a SOAR system. In some cases, a communication platform is native to another system when In some cases, a communication platform is native to another system when the communication platform is integrated with the other system. For example, a communication platform may be integrated with another system by: (i) enabling a user to access the communication platform via a UI of the other system, (ii) enabling the other system to access data associated with the communication platform via one or more APIs, (iii) enabling the communication platform to access data associated with the other system via one or more APIs, (iv) enabling a user to perform actions in the communication platform by performing actions in the other system, (v) enabling the other system to perform actions in the communication platform, and/or (vi) enabling the communication platform to perform actions in the other system. In some cases, when a communication platform is native to a system (e.g., a SOAR system), the communication platform and the system share a user provisioning functionality. For example, a user profile of the communication platform may be a user profile of the system, such that a user may use the same credentials to authenticate to the communication platform and the system. As another example, creating a user profile in the communication platform may create a corresponding user profile in the system, and vice versa. As another example, deleting a user profile in the communication platform may delete a corresponding user profile in the system, and vice versa.

In some cases, a communication interface is a designated space or channel within a communication platform that facilitates interaction between a defined set of users. For example, a communication interface may be a persistent chat room where users exchange messages, a dedicated page for a project team, or a shared workspace for collaborating on documents. In some cases, a communication interface is associated with a programmatic interface that enables a user and/or a software application to interact with a communication platform. For example, a communication interface may be a set of APIs that enable a software application to: (i) retrieve messages from the communication platform, (ii) send messages to the communication platform, (iii) create, retrieve, update, and/or delete user profiles associated with the communication platform, (iv) create, retrieve, update, and/or delete groups of users associated with the communication platform, (v) retrieve a history of communications associated with the communication platform, and/or (vi) configure settings associated with the communication platform.

In some cases, a user's communication with a native communication interface and using an external communication platform may be facilitated using a cross-platform communication system, which may, for example, execute operations associated with a software application that is integrated with the SOAR system and/or with the native communication platform. For example, the cross-platform communication system may operate as an intermediary and/or bridge between the native communication platform and the external communication platform.

In some cases, the cross-platform communication system may be configured to: (i) receive a communication provided by a user profile to a communication interface of the native communication platform, (ii) determine that the communication interface is associated with a plurality of user profiles, (iii) determine that the one of the plurality of user profiles is associated with the external communication platform (e.g., one of the plurality of user profiles has a link to a user profile on the external communication platform), (iv) retrieve a set of cross-platform conversion rules for converting communications originating in the native communication platform into communications posted to the external communication platform, (v) determine converted communication data based on the retrieved cross-platform conversion rule(s) and the received communication, and (vi) transmit the converted communication to a system (e.g., a software application integrated with the external communication platform) that is configured to post the converted communication to the external communication platform.

In some cases, the cross-platform communication system may be configured to: (i) receive a communication from the external communication platform that is directed to the communication interface of the native communication platform, (ii) determine that the message is associated with the external communication platform, (iii) retrieve a set of cross-platform conversion rules for converting communications originating in the external communication platform into communications posted to the native communication platform, (iv) determine converted communication based on the retrieved cross-platform conversion rule(s) and the received communication, and (v) post the converted communication to the native communication interface.

A cross-platform conversion rule may be a rule for converting a first communication associated with a source communication platform to a second communication associated with a destination communication platform. For example, a cross-platform conversion rule may include a rule to convert a first file type associated with the source communication platform to a second file type associated with the destination communication platform. As another example, a cross-platform conversion rule may include a rule to convert a first format associated with the source communication platform to a second format associated with the destination communication platform. As another example, a cross-platform conversion rule may include a rule to convert a first reaction associated with a reaction scheme of the source communication platform to a second reaction associated with a reaction scheme of the destination communication platform (e.g., convert a “thumps-up” reaction to a “like” reaction or vice versa).

In some cases, a rule for converting a first communication associated with a source communication platform into a second communication associated with a destination communication platform includes one or more of format conversion, file type conversion, content adaptation (e.g., content summarization), content redaction, translation, and/or notification handling. For example, in some cases, converting a first communication associated with a native communication platform into a second communication platform includes: (i) determining that the first communication is a communication to a communication platform that is native to a SOAR system, (ii) determining that the first communication includes a file and/or a link to a file, (iii) determining that the file is not accessible outside of the SOAR system, (iv) based on at least one of (ii) or (iii), retrieving content data associated with the file, (v) providing the content data as an input to a machine learning model (e.g., a generative machine learning model, a transformer-based machine learning model, an attention-based machine learning model, and/or the like), (vi) receiving, from the machine learning model, a summary of the content data, and (v) generating a converted communication that includes the summary. The converted communication may, for example, be posted to an external communication platform that is not native to the SOAR system. In some cases, the cross-platform communication may provide an artificial intelligence (AI) agent that a user can interact with by providing responses and/or receiving messages. The AI agent may, for example, use a trained language model and/or a trained generative language model.

For example, in some cases, In some cases, the AI agent may: (i) receive a user input via a first communication platform, (ii) process the user input using one or more natural language processing (NLP) models to determine an intent and/or context associated with the user input, (iii) generate a response based on the determined intent and/or context, and (iv) provide the generated response via a second communication platform. The AI agent may, for example, maintain context across multiple interactions and/or communication platforms. In some cases, the AI agent includes a conversation state manager that: (i) maintains a conversation history for each user interaction, (ii) tracks context variables across multiple communication platforms, and/or (iii) manages conversation flow based on predefined conversation models and/or dynamic learning from user interactions. For example, in some cases, when processing a user input received via a first communication platform, the conversation state manager may: (i) retrieve relevant context from previous interactions across multiple communication platforms, (ii) update the conversation state based on the current interaction, and (iii) store the updated conversation state for use in subsequent interactions.

As another example of cross-platform conversion rules, in some cases, converting a first communication associated with a native communication platform into a second communication platform includes: (i) determining that the first communication is a communication to a communication platform that is native to a SOAR system, (ii) determining that the first communication includes a data value corresponding to a sensitive data field, and (iii) based on (ii), generating a converted communication by redacting the sensitive data value. The converted communication may, for example, be posted to an external communication platform that is not native to the SOAR system. In some cases, to determine one or more data fields included in a communication, the cross-platform communication system: (i) receives a communication from a native communication platform, (ii) determines a data structure of the communication (e.g., determines that the communication is formatted as a Java Script Object Notation (JSON) object, determines that the communication is formatted as an Extensible Marup Language (XML) document, determines that the communication includes a set of key-value pairs, and/or the like), and (iii) based on the data structure, extracts one or more data fields from the communication. For example, if the communication is formatted as a JSON object, the cross-platform communication system may extract data fields by parsing the JSON object. As another example, if the communication is formatted as an XML document, the cross-platform communication system may extract data fields by parsing the XML document. As another example, if the communication includes a set of key-value pairs, the cross-platform communication system may extract data fields by identifying the keys and values in the communication. In some cases, to determine that a communication includes a sensitive data value, the cross-platform communication system: (i) receives a communication from a native communication platform, (ii) determines one or more data fields included in the communication, (iii) for each of the one or more data fields, determines whether the data field corresponds to a sensitive data field, and (iv) if one of the one or more data fields corresponds to a sensitive data field, determines that the communication includes a sensitive data value. In some cases, to determine whether a data field corresponds to a sensitive data field, the cross-platform communication system compares the data field to a set of sensitive data fields. For example, the cross-platform communication system may determine that a data field corresponds to a sensitive data field if the data field is included in the set of sensitive data fields. In some cases, the set of sensitive data fields is configurable (e.g., the set of sensitive data fields is configurable by an administrator of the cross-platform communication system).

As another example, in some cases, converting a first communication associated with a native communication platform into a second communication platform includes: (i) determining that the first communication is a communication to a first communication platform, (ii) determining that the first communication includes a first set of structured data (e.g., a JSON object, an XML document, a table, and/or the like), (iii) determining a second data structure that is compatible with a second communication platform, and (iv) based on (iii), converting the first set of structured data to the second data structure. In some cases, a communication platform represents structured data using a format that may be different from the structured data format used by another communication platform. For example, For example, a first communication platform may represent structured data using a first set of key-value pairs (e.g., a JSON object), while a second communication platform represents structured data using a second, different set of key-value pairs. In some cases, converting the first set of structured data to the second data structure includes: (i) determining a mapping between keys of the first set of key-value pairs and keys of the second set of key-value pairs, and (ii) based on the mapping, converting the first set of key-value pairs to the second set of key-value pairs. As another example, in some cases, converting a first communication associated with a native communication platform into a second communication platform includes: (i) determining that the first communication is a communication to a communication interface, (ii) determining that the communication interface is associated with a first set of users, (iii) determining that at least one of the first set of users is associated with a second communication platform, and (iv) converting the first communication to a second communication that is compatible with the second communication platform. The second communication may, for example, be posted to the second communication platform.

In some cases, a cross-platform communication system may be configured to convert communications between two or more communication platforms. For example, the cross-platform communication system may be configured to convert communications between a first communication platform (e.g., a Webex® communication platform) and a second communication platform (e.g., a Microsoft Teams® communication platform). In some cases, converting a communication from a first communication platform to a second communication platform includes addressing one or more technical complications. For example, the first communication platform may represent user mentions using a first format, while the second communication platform represents user mentions using a second, different format. The format of a mention may refer to the syntax used to identify and display a user within a message. For example, a first communication platform may represent a user mention using an “@” symbol followed by a username (e.g., “@john.doe”), while a second communication platform may represent a user mention using a different symbol, such as a “#” symbol, followed by a user ID (e.g., “#12345”). In some cases, converting a first communication associated with a first communication platform to a second communication associated with a second communication platform includes: (i) determining that the first communication includes a user mention that is formatted according to a first format, (ii) determining a second format for user mentions that is compatible with the second communication platform, and (iii) converting the user mention from the first format to the second format.

As another example, the first communication platform may represent timestamps associated with messages using a first format, while the second communication platform represents timestamps using a second, different format. The format of a timestamp may refer to the arrangement of date and time elements, such as the order of year, month, and day, or the use of 12-hour vs. 24-hour time representation. In some cases, converting a first communication associated with a first communication platform to a second communication associated with a second communication platform includes: (i) determining that the first communication includes a timestamp that is formatted according to a first format, (ii) determining a second format for timestamps that is compatible with the second communication platform, and (iii) converting the timestamp from the first format to the second format.

As another example, the first communication platform may represent message reactions using a first format, while the second communication platform represents message reactions using a second, different format. The format of a message reaction may refer to the type of reaction (e.g., “thumbs up”, “heart”, “smile”) and how it is displayed (e.g., as an emoji, as a text string, as an icon). In some cases, converting a first communication associated with a first communication platform to a second communication associated with a second communication platform includes: (i) determining that the first communication includes a message reaction that is formatted according to a first format, (ii) determining a second format for message reactions that is compatible with the second communication platform, and (iii) converting the message reaction from the first format to the second format. This may involve mapping similar reactions between platforms or providing a textual representation of a reaction if a direct equivalent is not available.

As another example, the first communication platform may represent hyperlinks using a first format, while the second communication platform represents hyperlinks using a second, different format. In some cases, converting a first communication associated with a first communication platform to a second communication associated with a second communication platform includes: (i) determining that the first communication includes a hyperlink that is formatted according to a first format, (ii) determining a second format for hyperlinks that is compatible with the second communication platform, and (iii) converting the hyperlink from the first format to the second format.

In some cases, a cross-platform conversion rule includes a rule for converting a communication associated with a communication platform to an action performed using a software application (e.g., where the software application may or may not be integrated with the external communication platform). For example, a cross-platform conversion rule may include a rule to convert a communication that includes a task assignment to an action of creating a task entry in a task management application. As another example, a cross-platform conversion rule may include a rule to convert a communication that includes an invite to an event to an action of creating an invite entry in a calendar management application. As another example, a cross-platform conversion rule may include a rule to convert a communication that includes a request to initiate an audio and/or video conference to an action of initiating an audio and/or video conference using a conferencing application.

In some cases, converting a communication associated with a communication platform to an action performed using a software application includes: (i) receiving a communication from a communication platform and associated with a communication interface, (ii) determining that the communication includes an indication of an action that may be performed using an external software application, (iii) determining (e.g., based on user profile data for a user profile associated with the communication interface) that a user profile associated with the communication interface is linked toa user profile of the external software application, (iv) based on (ii) and (iii), generating a request to cause the external software application to perform the action, and (v) transmitting the request to the external software application.

In some cases, the cross-platform communication system may include a predictive component that is configured to: (i) monitor the communications posted to a communication interface, (ii) determine, based on processing a set of communications posted to the communication interface using a first trained machine learning model, that the set of communications relate to a first subject matter (e.g., a first component of a monitored computing environment), (iii) retrieve log data associated with the first subject matter, (iv) determine, based on processing the log data using a second trained machine learning model, a description of the log data, and/or (v) post (e.g., using a bot message) the description to the communication interface.

In some cases, the predictive component of the cross-platform communication system is configured to: (i) receive a set of communications posted to the communication interface (e.g., a set of latest N communications posted to the communication interface, a set of communications posted in a threshold recent period, and/or the like), (ii) provide the set of communications to the first trained machine learning model, (iii) receiving, from the first model, that the set of communications relate to a first subject matter (e.g., a first component of a monitored computing environment, a first computing device, a first software application, a first location associated with a computing environment, and/or the like), (iv) based on the first subject matter, query a log database for log data associated with the first subject matter, (v) provide the log data to the second trained machine learning model, (vi) receive, from the second model, a prediction of an anomaly associated with the log data, and (vii) post a message to the communication interface that includes the prediction.

For example, if the first model determines that the set of communications relate to a first computing device (e.g., a first server identified by an IP address or hostname), the cross-platform communication system may query the log database for log data associated with the first computing device. The log data may include, for example, performance measurements, security logs, and/or the like. The second model may be configured to predict, based on the log data, that the first computing device is likely to fail within a threshold period (e.g., within 24 hours). The cross-platform communication system may post a message to the communication interface that includes the prediction. natural language processing (NLP) model that is configured to process a set of text-based communications and to determine a subject matter associated with the set of text-based communications. For example, the first trained machine learning model may be a transformer-based NLP model that is configured to: (i) receive a set of text-based communications, (ii) generate an embedding for each of the text-based communications, (iii) generate a combined embedding for the set of text-based communications based on the embeddings for each of the text-based communications, and (iv) classify the set of text-based communications based on the combined embedding. In some cases, the first trained machine learning model is a Latent Dirichlet Allocation (LDA) model. In some cases, the first trained machine learning model is a Bidirectional Encoder Representations from Transformers (BERT) model. In some cases, the first trained machine learning model is a Generative Pre-trained Transformer (GPT) model. In some cases, the first trained machine learning model is a Recurrent Neural Network (RNN).

In some cases, the second trained machine learning model is a time series forecasting model that is configured to process time series data. For example, the second trained machine learning model may be an Autoregressive Integrated Moving Average (ARIMA) model. In some cases, the second trained machine learning model is a Holt-Winters model. In some cases, the second trained machine learning model is a Long Short-Term Memory (LSTM) model. In some cases, the second trained machine learning model is a Gated Recurrent Unit (GRU) model.

In some cases, the cross-platform communication system is configured to: (i) receive a set of communications posted to the communication interface, (ii) determine, based on processing the set of communications using a first trained machine learning model, that the set of communications relate to a first subject matter, (iii) retrieve log data associated with the first subject matter, (iv) determine, based on processing the log data using a second trained machine learning model, a description of the log data, and (v) post the description to the communication interface. In some cases, posting the description to the communication interface includes posting the description to the communication interface using a bot message. For example, the cross-platform communication system may include a bot interface that enables a software application to interact with the communication interface. The cross-platform communication system may use the bot interface to post the description to the communication interface.

In some cases, the cross-platform communication system may be configured to provide a proactive communication service. For example, the cross-platform communication system may be configured to: (i) monitor a first communication platform (e.g., a communication platform that is native to a SOAR system) for communications that include a request for assistance, (ii) determine, based on the request for assistance, a subject matter associated with the request (e.g., a topic of the request, a component of a computing environment associated with the request, and/or the like), (iii) determine a set of one or more users associated with the subject matter, (iv) for each user in the set of one or more users, determine an availability status (e.g., determine whether the user is “available”, “busy”, “away”, and/or the like), (v) select one or more users from the set of one or more users based on the availability status (e.g., select users that are determined to be “available”), (vi) for the selected one or more users, determine a second communication platform associated with the user (e.g., an external communication platform associated with the user), and (vii) send a notification to the selected one or more users using the second communication platform. The notification may include a request to assist with the request for assistance monitored in (i). In some cases, the cross-platform communication system may be configured to: (i) monitor a first communication platform (e.g., a communication platform that is native to a SOAR system) for communications that include a request for assistance, (ii) determine, based on the request for assistance, a subject matter associated with the request (e.g., a topic of the request, a component of a computing environment associated with the request, and/or the like), (iii) determine a set of one or more users associated with the subject matter, (iv) rank the set of one or more users based on one or more attributes associated with each user (e.g., rank users based on a level of expertise associated with a subject matter, rank users based on a response time associated with each user, rank users based on an availability status associated with each user, and/or the like), (v) select one or more users from the ranked set of one or more users (e.g., select a highest ranked user, select a set of N highest ranked users, and/or the like), (vi) for the selected one or more users, determine a second communication platform associated with the user (e.g., an external communication platform associated with the user), and (vii) send a notification to the selected one or more users using the second communication platform. The notification may include a request to assist with the request for assistance monitored in (i).

In some cases, the cross-platform communication system may be configured to facilitate communications associated with an incident response process. For example, the cross-platform communication system may be configured to: (i) monitor a communication platform for a communication that corresponds to an initiation of an incident response process (e.g., a communication that includes a declaration of an incident, a communication that includes a declaration of a security event, a communication that includes a request to initiate an incident response procedure, and/or the like), (ii) in response to identifying a communication that corresponds to an initiation of an incident response process, generate a communication interface (e.g., a communication channel, a chat room, a discussion forum, and/or the like) associated with the incident response process, (iii) determine a set of users associated with the incident response process (e.g., a set of users associated with an on-call schedule, a set of users associated with a security operations team, and/or the like), (iv) for each of the set of users, determine a communication platform associated with the user (e.g., an external communication platform associated with the user), and (v) send a notification to each of the set of users using the communication platform associated with the user. The notification may include, for example, (i) a notification of the initiation of the incident response process, (ii) a subject matter associated with the incident response process, and (iii) an invitation to join the communication interface generated in (ii).

In some cases, the cross-platform communication system may be configured to facilitate communications associated with a threat intelligence process. For example, the cross-platform communication system may be configured to: (i) monitor a threat intelligence platform for a threat intelligence communication (e.g., a communication that includes a threat alert, a communication that includes a threat indicator, a communication that includes a threat report, and/or the like), (ii) in response to identifying a threat intelligence communication, determine a set of users that are subscribed to the threat intelligence communication (e.g., a set of users that have indicated an interest in a subject matter associated with the threat intelligence communication, a set of users that have opted to receive notifications about threat intelligence communications, and/or the like), (iii) for each of the set of users, determine a communication platform associated with the user (e.g., an external communication platform associated with the user), and (iv) send a notification to each of the set of users using the communication platform associated with the user. The notification may include, for example, the threat intelligence communication or a summary thereof.

In some cases, the cross-platform communication system may be configured to facilitate communications associated with a vulnerability management process. For example, the cross-platform communication system may be configured to: (i) monitor a vulnerability scanner for a vulnerability communication (e.g., a communication that includes a vulnerability alert, a communication that includes a vulnerability report, a communication that includes a vulnerability scan result, and/or the like), (ii) in response to identifying a vulnerability communication, determine a set of users that are associated with the vulnerability communication (e.g., a set of users that are responsible for a system associated with the vulnerability communication, a set of users that have indicated an interest in a subject matter associated with the vulnerability communication, a set of users that have opted to receive notifications about vulnerability communications, and/or the like), (iii) for each of the set of users, determine a communication platform associated with the user (e.g., an external communication platform associated with the user), and (iv) send a notification to each of the set of users using the communication platform associated with the user. The notification may include, for example, the vulnerability communication or a summary thereof.

In some cases, the techniques described herein may reduce a computational load associated with a SOAR system by enabling a user to communicate with a native communication interface using an external communication platform. In some cases, a SOAR system is configured to execute a plurality of software applications on one or more computing devices, wherein each of the software applications is configured to perform a set of operations associated with facilitating the automation of security operations. In some cases, one or more of the software applications are computationally intensive software applications (e.g., one or more of the software applications may be configured to perform a set of operations that consume a significant amount of processing power, memory resources, and/or the like). For example, in some cases, a SOAR system executes a first software application that is configured to monitor one or more computing environments to detect security threats, wherein the first software application is a computationally intensive software application. As another example, in some cases, a SOAR system executes a second software application that is configured to analyze security logs to identify security incidents, wherein the second software application is a computationally intensive software application. As another example, in some cases, a SOAR system executes a third software application that is configured to automatically respond to security incidents, wherein the third software application is a computationally intensive software application. In some cases, enabling a user to communicate with a native communication interface using an external communication platform may reduce an amount of data that is communicated to the SOAR system, which may reduce a computational load associated with processing the data. For example, in some cases, a user may use an external communication platform to filter communications before they are communicated to the SOAR system, which may reduce an amount of data that is communicated to the SOAR system.

In some cases, the techniques described herein improve the reliability of a SOAR system by enabling users to communicate with the SOAR system in the absence of the availability of the SOAR system's native communication platform. For example, in some cases, even when the native communication platform is unavailable, the cross-platform communication system may enable bidirectional communication between user profiles associated with a communication interface, for example using the techniques described herein. In this way, the cross-platform communication system may be able to maintain “virtual” access to the native communication platform even in the absence of availability of that platform. Accordingly, in some cases, the techniques described herein may improve the resilience of a SOAR system. For example, in some cases, a SOAR system is configured to operate in a first mode when the native communication platform is available and to operate in a second mode when the native communication platform is unavailable. In the first mode, the SOAR system may be configured to provide a first set of functionalities, while in the second mode, the SOAR system may be configured to provide a second set of functionalities. The second set of functionalities may be a subset of the first set of functionalities. For example, in the first mode, the SOAR system may be configured to provide a first set of functionalities that includes communication functionalities, while in the second mode, the SOAR system may be configured to provide a second set of functionalities that does not include communication functionalities. In some cases, the cross-platform communication system enables the SOAR system to provide communication functionalities in the second mode. For example, the cross-platform communication system may be configured to provide a virtual communication interface that emulates the native communication interface. In this way, the cross-platform communication system may enable the SOAR system to provide a same set of functionalities in the first mode and the second mode.

In some cases, the techniques described herein improve the user experience associated with a SOAR system. For example, in some cases, a user may prefer to use an external communication platform to communicate with the SOAR system. In some cases, enabling the user to communicate with the SOAR system using the external communication platform may improve the user's experience. For example, the user may be more familiar with the user interface of the external communication platform, or the user may find the external communication platform to be more user-friendly. In some cases, enabling a user to communicate with a native communication interface using an external communication platform may reduce a number of different communication platforms that the user is required to use, which may improve the user's experience. For example, in some cases, a user may be required to use a different communication platform for each SOAR system that the user interacts with. In some cases, enabling the user to communicate with each SOAR system using the same external communication platform may reduce a number of different communication platforms that the user is required to use, which may improve the user's experience.

In some cases, the predictive component of the cross-platform communication system may improve the efficiency of security operations by proactively identifying and alerting users to potential security incidents. In some cases, the predictive component may reduce the time it takes to detect and respond to security incidents. For example, the predictive component may identify a security incident before it is reported by a user. In some cases, the predictive component may improve the accuracy of security incident detection. For example, the predictive component may be configured to use machine learning models that are trained on a large dataset of security incident data, which may improve the accuracy of the models.

In some cases, the predictive component of the cross-platform communication system improves the effectiveness of communication between users of the SOAR system. For example, the predictive component may be configured to: (i) monitor the communication interface for mentions of security incidents, (ii) retrieve relevant information about the security incidents from a knowledge base, and (iii) provide the relevant information to the users. In some cases, the knowledge base is a database that stores information about security incidents, such as incident descriptions, severity levels, and/or remediation steps. In some cases, the predictive component retrieves relevant information by: (i) identifying keywords in the communication interface that are associated with security incidents, (ii) querying the knowledge base for information about the security incidents that are associated with the keywords, and (iii) selecting the information that is most relevant to the users.

In some cases, the cross-platform communication system includes a platform-specific adapter component that: (i) handles platform-specific authentication requirements, (ii) manages platform-specific rate limits and API constraints, (iii) implements platform-specific message formatting rules, and/or (iv) handles platform-specific error conditions. The platform-specific adapter component may, for example, maintain a configuration repository that stores platform-specific parameters, authentication credentials, and/or formatting templates for each supported communication platform. In some cases, the platform-specific adapter component dynamically updates its configuration based on changes in platform requirements and/or API specifications.

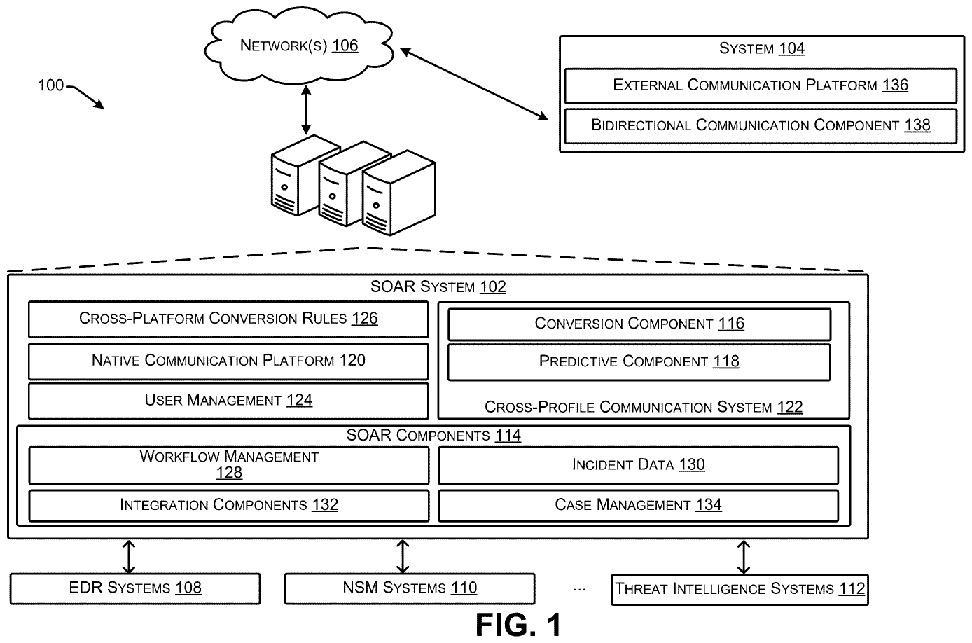

FIG. 1 provides an example architecture 100 for enabling a user of a SOAR system 102 to communicate with a native communication platform 120 using an external communication platform 136. The architecture 100 includes a cross-platform communication system 122 that is configured to facilitate communication between the native communication platform 120 and the external communication platform 136.

The SOAR system 102 may be a system that is configured to facilitate the automation of security operations related to one or more computing environments. The SOAR system 102 may be configured to communicate with one or more computing systems (e.g., system 104) via one or more networks 106. As depicted in FIG. 1, the SOAR system may include a set of SOAR components 114, including one or more of a workflow management component 128, the incident data component 130, integration components 132, and a case management component 134.

The workflow management component 128 may be a SOAR component that is configured to manage a set of workflows. For example, the workflow management component 128 may be configured to: (i) store a set of workflow definitions, (ii) receive a request to execute a workflow, (iii) based on the request, retrieve a corresponding workflow definition, (iv) execute operations associated with the workflow definition, (v) monitor the execution of the operations, and/or (vi) generate a report on the execution of the operations. In some cases, a workflow definition is a set of instructions for performing a task. For example, a workflow definition may be a set of instructions for investigating a security alert. As another example, a workflow definition may be a set of instructions for remediating a security vulnerability. In some cases, the workflow management component 128 enables a user to create, retrieve, update, and/or delete workflow definitions. In some cases, the workflow management component 128 enables a user to execute a workflow definition. In some cases, the workflow management component 128 enables a user to monitor the execution of a workflow definition. In some cases, the workflow management component 128 enables a user to generate a report on the execution of a workflow definition.

The incident data component 130 may be a SOAR component that is configured to store incident data. Incident data may be data that is associated with a security incident. For example, incident data may include one or more of: (i) security alerts, (ii) security logs, (iii) threat intelligence data, (iv) vulnerability data, (v) incident reports, (vi) case notes, and/or (vii) user communications. In some cases, the incident data component 130 enables a user to create, retrieve, update, and/or delete incident data. In some cases, the incident data component 130 enables a user to search incident data. In some cases, the incident data component 130 enables a user to correlate incident data. In some cases, the incident data component 130 enables a user to generate reports on incident data.

The integration components 132 may be SOAR components that are configured to integrate the SOAR system 102 with one or more other systems. For example, the integration components 132 may be configured to integrate the SOAR system 102 with one or more of: (i) a threat intelligence platform for aggregating and processing threat intelligence data, (ii) a SIEM system for collecting and processing security logs, (iii) a vulnerability scanner for identifying security vulnerabilities, (iv) an EDR system for detecting and responding to security threats on endpoints, (v) a NSM system for detecting and responding to security threats on a network, (vi) a case management system for managing security incidents, (vii) a workflow engine for automating security playbooks, and/or (viii) a reporting engine for generating reports on security incidents. In some cases, an integration component 132 is configured to communicate with another system via one or more APIs. For example, an integration component 132 may be configured to retrieve data from another system via an API. As another example, an integration component 132 may be configured to send data to another system via an API.

For example, in the specific example depicted in FIG. 1, the integration components 132 integrate the SOAR system 102 with a set of EDR systems 108, a set of NSM systems 110, and a threat intelligence platform 112. An EDR system may be configured to monitor endpoints (e.g., computing devices such as user computers, servers, and/or mobile devices) for security threats. For example, an EDR system may be configured to: (i) collect security-related data from endpoints, such as process logs, network traffic logs, and file system activity logs; (ii) process the collected data for signs of malicious activity; (iii) generate alerts based on the analysis; and/or (iv) take actions to respond to detected threats, such as isolating infected endpoints or terminating malicious processes. In some cases, an EDR system includes one or more software agents that are installed on endpoints. The software agents may be configured to collect data from the endpoints and transmit the data to a central management server. The central management server may be configured to process the data and generate alerts.

An NSM system may be configured to monitor network traffic for security threats. For example, an NSM system may be configured to: (i) capture network traffic; (ii) process the captured traffic for signs of malicious activity; (iii) generate alerts based on the analysis; and/or (iv) take actions to respond to detected threats, such as blocking malicious traffic or isolating infected devices. In some cases, an NSM system includes one or more network sensors that are deployed on the network. The network sensors may be configured to capture network traffic and transmit the traffic to a central management server. The central management server may be configured to process the traffic and generate alerts.

A threat intelligence platform may be configured to aggregate and process threat intelligence data. Threat intelligence data may be data that is related to security threats. For example, threat intelligence data may include one or more of: (i) information about known malware, (ii) information about known vulnerabilities, (iii) information about attacker tactics, techniques, and procedures (TTPs), and/or (iv) information about indicators of compromise (IOCs). In some cases, a threat intelligence platform enables a user to: (i) collect threat intelligence data from various sources, such as open-source feeds, commercial feeds, and internal sources; (ii) process the collected data to extract relevant information; (iii) store the processed data in a central repository; (iv) process the processed data to identify trends and patterns; and/or (v) share the processed data with other security tools and systems.

The case management component 134 may be a SOAR component that is configured to manage security incidents. For example, the case management component 134 may be configured to: (i) track the status of security incidents, (ii) assign security incidents to security analysts, (iii) escalate security incidents to other security analysts, (iv) generate reports on security incidents, and/or (v) close security incidents. In some cases, the case management component 134 enables a user to create, retrieve, update, and/or delete security incidents. In some cases, the case management component 134 enables a user to search security incidents. In some cases, the case management component 134 enables a user to correlate security incidents. In some cases, the case management component 134 enables a user to generate reports on security incidents.

As further depicted in FIG. 1, the SOAR system 102 may include a native communication platform 120, which may be a communication platform that is native to the SOAR system 102. The native communication platform 120 may be a software application and/or a computer system executing operations associated with a software application that facilitates communication between two or more users.

The native communication platform 120 may include a communication interface that enables a user to interact with the native communication platform 120. For example, the communication interface may include one or more GUI elements that enable a user to compose and send messages, view received messages, and manage communication channels.

The SOAR system 102 may also include a cross-platform communication system 122. The cross-platform communication system 122 may be configured to facilitate communication between the native communication platform 120 and the external communication platform 136. The cross-platform communication system 122 may be a software application and/or a computer system executing operations associated with a software application. As depicted in FIG. 1, the cross-platform communication system 122 may include a conversion component 116 and a predictive component 118.

The conversion component 116 may be configured to convert a communication originating from the native communication platform 120 into a communication associated with the external communication platform 126, or vice versa. For example, the conversion component 116 may be configured to: (i) receive a communication originating from the native communication platform 120, (ii) determine that the communication is associated with the external communication platform 126 (e.g., is associated with a user profile linked to the external communication platform 126), (iii) retrieve one or more communication conversion rules associated with the external communication platform 126, and/or (iv) determine a converted communication based on the received communication and the conversion rule(s0. As another example, the conversion component 116 may be configured to: (i) receive a communication originating from the external communication platform 126, (iii) determine that the communication is associated with the native communication platform 120 (e.g., is associated with a user profile linked to the native communication platform 120), (iii) retrieve one or more communication conversion rules associated with the native communication platform 120, and/or (iv) determine a converted communication based on the received communication and the conversion rule(s).

In some cases, the conversion component 116 is configured to: (i) receive a communication from the native communication platform 120, (ii) determine one or more data fields included in the communication, (iii) for each of the one or more data fields, determine whether the data field corresponds to a sensitive data field, and (iv) if one of the one or more data fields corresponds to a sensitive data field, redact the sensitive data field. In some cases, the conversion component 116 determines that a data field corresponds to a sensitive data field when the data field is included in a configurable set of sensitive data fields. For example, an administrator of the SOAR system 102 may configure the set of sensitive data fields to include data fields corresponding to personally identifiable information (PII), such as names, email addresses, and phone numbers. As another example, the administrator may configure the set of sensitive data fields to include data fields corresponding to sensitive security information, such as IP addresses, hostnames, and vulnerability details.

In some cases, the conversion component 116 is configured to convert structured data included in a communication. For example, the conversion component 116 may be configured to: (i) receive a communication from the native communication platform 120, (ii) determine that the communication includes structured data (e.g., a JSON object, an XML document, a table, and/or the like), (iii) determine a second data structure that is compatible with the external communication platform 136, and (iv) based on (iii), convert the structured data to the second data structure. In some cases, a communication platform represents structured data using a format that may be different from the structured data format used by another communication platform. For example, a first communication platform may represent structured data using a first set of key-value pairs (e.g., a JSON object), while a second communication platform represents structured data using a second, different set of key-value pairs. In some cases, converting the first set of structured data to the second data structure includes: (i) determining a mapping between keys of the first set of key-value pairs and keys of the second set of key-value pairs, and (ii) based on the mapping, converting the first set of key-value pairs to the second set of key-value pairs.

In some cases, the conversion component 116 is configured to convert a user mention included in a communication. For example, the conversion component 116 may be configured to: (i) receive a communication from the native communication platform 120, (ii) determine that the communication includes a user mention that is formatted according to a first format, (iii) determine a second format for user mentions that is compatible with the external communication platform 136, and (iv) convert the user mention from the first format to the second format.

In some cases, the conversion component 116 is configured to convert a timestamp included in a communication. For example, the conversion component 116 may be configured to: (i) receive a communication from the native communication platform 120, (ii) determine that the communication includes a timestamp that is formatted according to a first format, (iii) determine a second format for timestamps that is compatible with the external communication platform 136, and (iv) convert the timestamp from the first format to the second format.

In some cases, the conversion component 116 is configured to convert a message reaction included in a communication. For example, the conversion component 116 may be configured to: (i) receive a communication from the native communication platform 120, (ii) determine that the communication includes a message reaction that is formatted according to a first format, (iii) determine a second format for message reactions that is compatible with the external communication platform 136, and (iv) convert the message reaction from the first format to the second format.

In some cases, the conversion component 116 is configured to convert a hyperlink included in a communication. For example, the conversion component 116 may be configured to: (i) receive a communication from the native communication platform 120, (ii) determine that the communication includes a hyperlink that is formatted according to a first format, (iii) determine a second format for hyperlinks that is compatible with the external communication platform 136, and (iv) convert the hyperlink from the first format to the second format.

The predictive component 118 may be configured to monitor communications in the native communication platform 120 and to provide related communications based on the communications in the native communication platform 120. For example, the predictive component 118 may be configured to: (i) monitor the communications posted to a communication interface of the native communication platform 120, (ii) determine, based on processing a set of communications posted to the communication interface using a first trained machine learning model, that the set of communications relate to a first subject matter (e.g., a first component of a monitored computing environment), (iii) retrieve log data associated with the first subject matter, (iv) determine, based on processing the log data using a second trained machine learning model, a description of the log data, and (v) post (e.g., using a bot message) the description to the communication interface.

In some cases, the cross-platform communication system 122 may use one or more communication protocols to communicate with the external communication platform 136 and/or the bidirectional communication component 138. For example, the cross-platform communication system 122 may use one or more of: (i) the Hypertext Transfer Protocol (HTTP), (ii) the WebSockets protocol, (iii) the Extensible Messaging and Presence Protocol (XMPP), and/or (iv) the Message Queuing Telemetry Transport (MQTT) protocol. In some cases, to communicate with the cross-platform communication system 122, the bidirectional communication component 138 uses one or more communication protocols, such as one or more of the described protocols. In some cases, the cross-platform communication system 122 may maintain a persistent communication with the external communication platform 136 and/or the bidirectional communication component 138. In some cases, the bidirectional communication component 138 is configured to handle communication errors. For example, the cross-platform communication system 122 may be configured to: (i) detect communication errors, (ii) retry failed communications, (iii) generate alerts for communication errors, and/or (iv) log communication errors.

As further depicted in FIG. 1, the SOAR system 102 may also include a user management component 124. The user management component 124 may be configured to manage user profiles associated with the SOAR system 102. For example, the user management component 124 may be configured to: (i) store user profiles, (ii) authenticate users, (iii) authorize users to access resources, (iv) manage user roles and permissions, and/or (v) provide a user interface for managing user profiles. In some cases, a user profile is a record that stores information about a user. For example, a user profile may include one or more of: (i) a user's name, (ii) a user's email address, (iii) a user's password, (iv) a user's role, (v) a user's permissions, and/or (vi) a user's preferences. In some cases, the user management component 124 enables a user to create, retrieve, update, and/or delete user profiles. In some cases, the user management component 124 enables a user to search user profiles. In some cases, the user management component 124 enables a user to generate reports on user profiles.

In some cases, the user management component 124 is integrated with the native communication platform 120. For example, the user management component 124 may be configured to: (i) provision user profiles in the native communication platform 120, (ii) deprovision user profiles in the native communication platform 120, (iii) update user profiles in the native communication platform 120, and/or (iv) retrieve user profiles from the native communication platform 120.

In some cases, the user management component 124 is integrated with the external communication platform 136. For example, the user management component 124 may be configured to: (i) provision user profiles in the external communication platform 136, (ii) deprovision user profiles in the external communication platform 136, (iii) update user profiles in the external communication platform 136, and/or (iv) retrieve user profiles from the external communication platform 136.

As further depicted in FIG. 1, the system 104 communicates with the SOAR system 102 using one or more networks 106. The system 104 may, for example, include the external communication platform 136 and the bidirectional communication component 138. The external communication platform 136 may be a communication platform that is not native to the SOAR system 102. The external communication platform 136 may be a software application and/or a computer system executing operations associated with a software application that facilitates communication between two or more users. The external communication platform 136 may include a communication interface that enables a user to interact with the external communication platform 136. For example, the communication interface may include one or more GUI elements that enable a user to compose and send messages, view received messages, and manage communication channels.

The bidirectional communication component 138 may be configured to facilitate bidirectional communication between the native communication platform 120 and the external communication platform 136. For example, the bidirectional communication component 138 may be configured to: (i) receive a converted communication from the native communication platform 120, (ii) transmit the converted communication to the external communication platform 136, (iii) receive a response to the communication from the external communication platform 136, and (iv) transmit the response to the native communication platform 120. As another example, the bidirectional communication component 138 may be configured to: (i) receive a communication from the external communication platform 136, (ii) transmit the communication to the native communication platform 120, (iii) receive a response to the communication from the native communication platform 120, and (iv) transmit the response to the external communication platform 136.

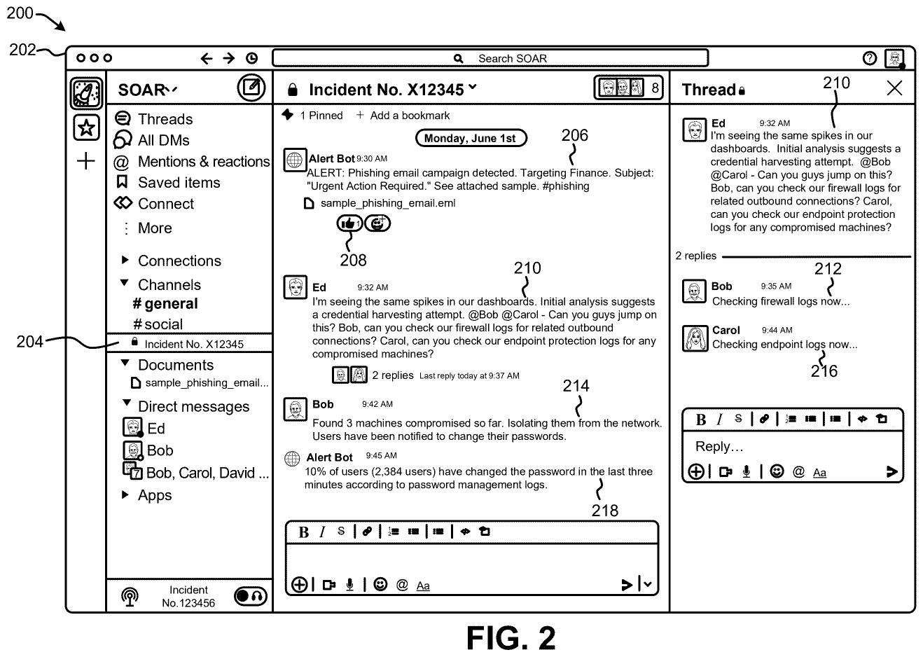

FIG. 2 provides an operational example 200 of a user interface 202 of a native communication platform of a SOAR system. The user interface 202 displays a set of communications associated with a communication interface 204, which is associated with a particular security incident.

As depicted in FIG. 2, the communication interface 204 includes a set of communications. The communication interface 204 also includes a display area for displaying the replies to a selected thread. The communication interface 204 further includes a message input area.

The set of communications includes a message 206. The message 206 is a communication from a bot. The message 206 includes a timestamp indicating that the message 206 was sent at 9:30 AM. The message 206 includes text indicating an alert. The message 206 also includes a file attachment. The file attachment is named “sample_phishing_email.eml”.

The set of communications also includes a reaction 208. The reaction 208 is associated with the message 206. The reaction 208 is a “thumbs up” reaction.

The set of communications further includes a message 210. The message 210 is a communication from a user. The message 210 includes a timestamp indicating that the message 210 was sent at 9:32 AM. The message 210 includes text indicating that the user is seeing spikes in dashboards. The message 210 also includes text indicating that the user believes the spikes are associated with a credential harvesting attempt. The message 210 further includes mentions of two other users.

The set of communications additionally includes a message 212. The message 212 is a reply to the message 210. The message 212 is a communication from the user. The message 212 includes a timestamp indicating that the message 212 was sent at 9:35 AM. The message 212 includes text indicating that the user is checking firewall logs.

The set of communications also includes a message 214. The message 214 is a reply to the message 210. The message 214 is a communication from the user. The message 214 includes a timestamp indicating that the message 214 was sent at 9:44 AM. The message 214 includes text indicating that the user is checking endpoint logs.

The set of communications further includes a message 216. The message 216 is a communication from the user. The message 216 includes a timestamp indicating that the message 216 was sent at 9:45 AM. The message 216 includes text indicating that the user found three compromised machines. The message 216 also includes text indicating that the user is isolating the machines and notifying the users to change their passwords.

The set of communications additionally includes a message 218. The message 218 is a communication from a bot. The message 218 includes a timestamp indicating that the message 218 was sent at 10:45 AM. The message 218 includes text indicating that 10% of users have changed their passwords in the last three minutes. This text may, for example, have been generated based on: (i) determining that the message 216 relates to notifying users to change their passwords, and (ii) determining (e.g., based on log data and/or system monitoring data) that 10% of users have changed their passwords in the last three minutes.

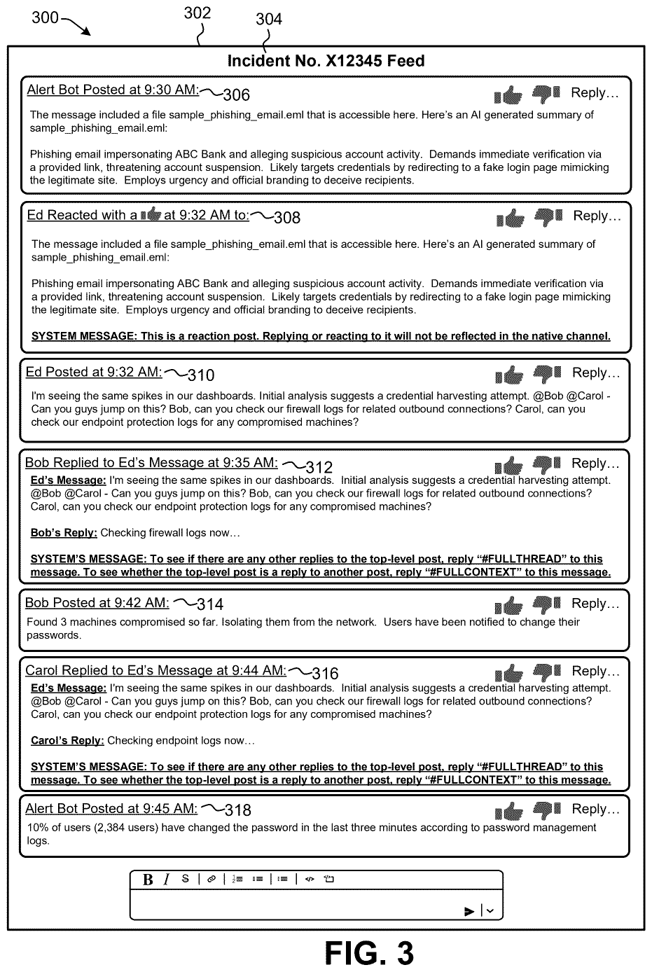

FIG. 3 provides an operational example 300 of a user interface 302 of an external communication platform. The user interface 302 displays a set of converted communications in a message thread 304. The converted communications were generated based on the communications depicted in FIG. 2.

As depicted in FIG. 3, the message thread 304 includes a message 306. The message 306 was generated based on converting the message 206 from FIG. 2. The message 306 includes a timestamp indicating that the message 306 was sent at 9:30 AM. The message 306 includes text indicating an alert. The message 306 also includes text summarizing a file attachment. The file attachment is named “sample_phishing_email. eml”. The message 306 further includes a hyperlink to the file attachment.

The message thread 304 also includes a message 308. The message 308 was generated based on converting the reaction 208 from FIG. 2. The message 308 includes a timestamp indicating that the message 308 was sent at 9:32 AM. The message 308 includes text indicating that a user reacted to the message 306. The message 308 also includes text indicating that the reaction was a “thumbs up” reaction. The message 308 further includes a system message. The system message indicates that the message 308 is a reaction post. The system message also indicates that replying or reacting to the message 308 will not be reflected in the native communication platform (e.g., in the communication interface 204).

The message thread 304 further includes a message 310. The message 310 was generated based on converting the message 210 from FIG. 2. The message 310 includes a timestamp indicating that the message 310 was sent at 9:32 AM. The message 310 includes text indicating that a user is seeing spikes in dashboards. The message 310 also includes text indicating that the user believes the spikes are associated with a credential harvesting attempt. The message 310 further includes mentions of two other users.

The message thread 304 additionally includes a message 312. The message 312 was generated based on converting the message 212 from FIG. 2. The message 312 includes a timestamp indicating that the message 312 was sent at 9:35 AM. The message 312 includes text indicating that the message 312 is a reply to the message 310. The message 312 also includes the text of the message 310. The message 312 further includes text indicating that a user is checking firewall logs. The message 312 additionally includes a system message. The system message indicates that, to see if there are any other replies to the top-level post, the user of the external communication platform can reply “#FULLTHREAD” to the message 312. The system message also indicates that, to see whether the top-level post is a reply to another post, the user of the external communication platform can reply “#FULLCONTEXT” to the message 312.

The message thread 304 also includes a message 314. The message 314 was generated based on converting the message 214 from FIG. 2. The message 314 includes a timestamp indicating that the message 314 was sent at 9:42 AM. The message 314 includes text indicating that a user found three compromised machines. The message 314 also includes text indicating that the user is isolating the machines and notifying the users to change their passwords.

The message thread 304 further includes a message 316. The message 316 was generated based on converting the message 216 from FIG. 2. The message 316 includes a timestamp indicating that the message 316 was sent at 9:44 AM. The message 316 includes text indicating that the message 316 is a reply to the message 310. The message 316 also includes the text of the message 310. The message 316 further includes text indicating that a user is checking endpoint logs. The message 316 additionally includes a system message. The system message indicates that, to see if there are any other replies to the top-level post, the user of the external communication platform can reply “#FULLTHREAD” to the message 316. The system message also indicates that, to see whether the top-level post is a reply to another post, the user of the external communication platform can reply “#FULLCONTEXT” to the message 316.

The message thread 304 additionally includes a message 318. The message 318 was generated based on converting the message 218 from FIG. 2. The message 318 includes a timestamp indicating that the message 318 was sent at 9:45 AM. The message 318 includes text indicating that 10% of users have changed their passwords in the last three minutes.

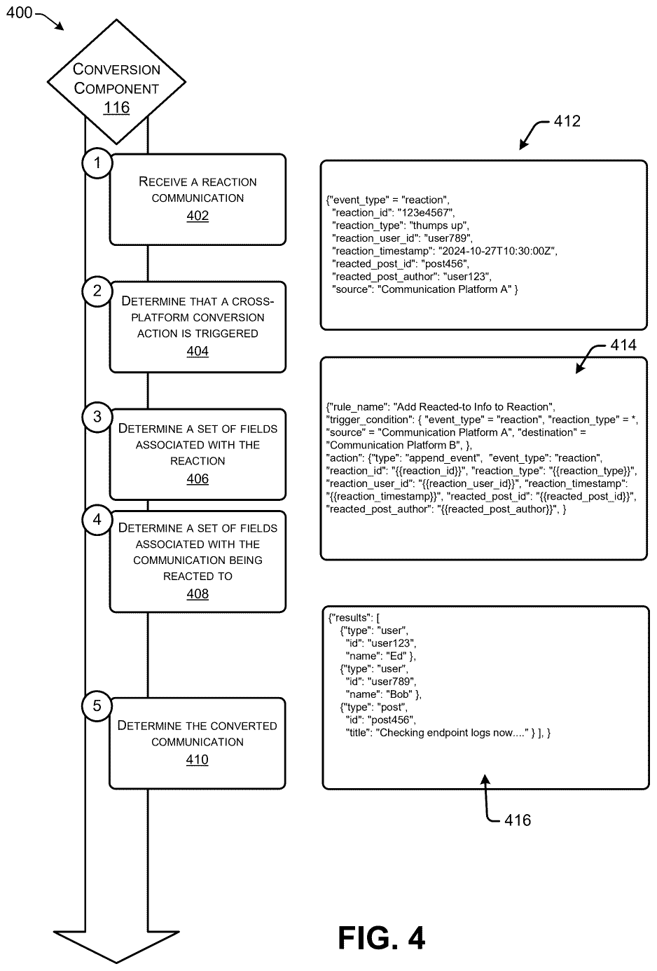

FIG. 4 is a flowchart diagram of an example process 400 for generating a converted communication based on a reaction communication. As depicted in FIG. 4, at operation 402, the conversion component 116 receives a reaction communication. The reaction communication may be a reaction to another communication (referred to herein as the “reacted-to communication”). An example of a reaction communication 412 is depicted in FIG. 4.

At operation 404, the conversion component 116 determines that a cross-platform conversion rule is triggered. The cross-platform conversion rule may be associated with reactions. In some cases, the cross-platform conversion rule is associated with the type of reaction communication. For example, a “like” reaction may trigger a first rule, a “dislike” reaction may trigger a second rule, a “heart” reaction may trigger a third rule, and/or the like. In some cases, the cross-platform conversion rule is associated with a type of the reacted-to communication. For example, a reaction to a message containing a link may trigger a rule different from a reaction to a message containing only text. In some cases, the cross-platform conversion rule is associated with a combination of the type of reaction and the type of the reacted-to communication. An example of a cross-platform conversion rule 414 is depicted in FIG. 4.

At operation 406, the conversion component 116 determines a first set of fields associated with the reaction. The first set of fields may include, for example, the type of reaction, an identifier of the user who performed the reaction, a timestamp associated the reaction, and/or the like. In some cases, determining the first set of fields include converting one or more attributes associated with the reaction using the conversion rule(s) and/or based on one or more formatting requirements of the external communication platform. For example, in some cases, the external communication platform may represent reactions with numerical identifiers. The conversion rule may specify a mapping between these numerical identifiers and textual descriptions of the reactions. For example, based on a conversion rule, a “thumps-up” reaction may map to a “like” reaction and a “thumps-down” reaction may map to a “dislike” reaction.

At operation 408, the conversion component 116 determines a second set of fields associated with the reacted-to communication. The second set of fields may include, for example, the content of the reacted-to communication, an identifier of the user who sent the reacted-to communication, a timestamp associated with the reacted-to communication, and/or the like. In some cases, determining the second set of fields include converting one or more attributes associated with the reacted-to post using the conversion rule(s) and/or based on one or more formatting requirements of the external communication platform. For example, in some cases, a conversion rule may specify that, if a user identifier associated with the reacted-to communication is linked to a user identifier of the external communication profile, then the linked user identifier of the external communication profile should be included in the second set of fields. As another example, in some cases, a conversion rule may specify that a numerical user identifier associated with the reacted-to communication should be converted to a text string containing the username associated with that user identifier.

At operation 410, the conversion component 116 determines the converted communication based on the first and the second set of fields. In some cases, the converted communication is a communication that is compatible with one or more requirements of a destination communication platform. In some cases, the converted communication may be transmitted to and/or displayed using the destination communication platform. An example of a converted communication 416 is depicted in FIG. 4.

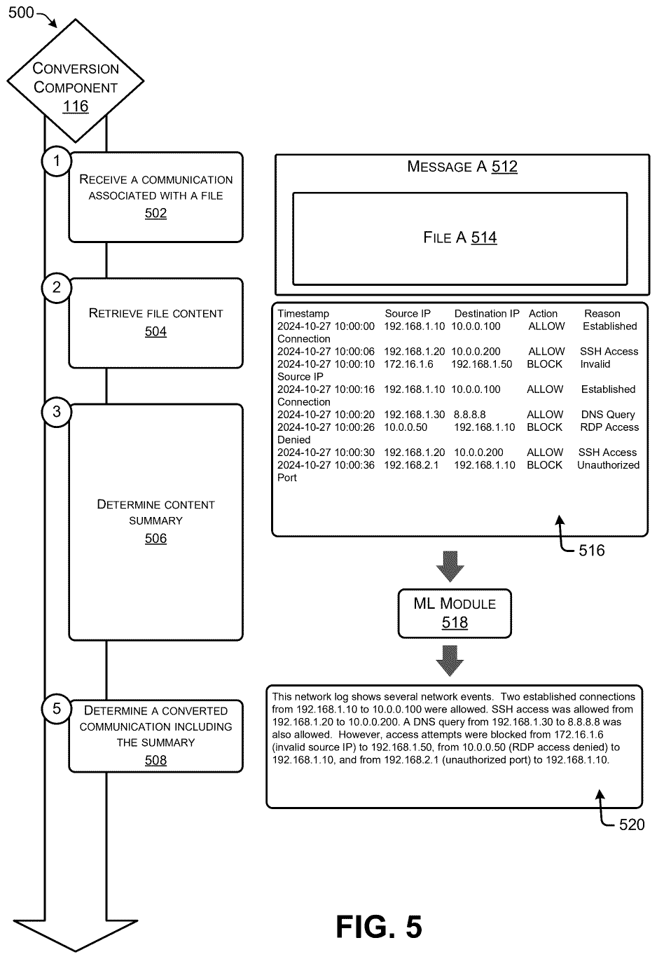

FIG. 5 is a flowchart diagram of an example process 500 for generating a converted communication based on a communication associated with a file. As depicted in FIG. 5, at operation 502, the conversion component 116 receives a communication associated with a file. In some cases, the communication includes the file. In some cases, the communication includes a link to the file. In some cases, the communication includes a reference to the file. An example of a communication 512 with a file 514 is depicted in FIG. 5.

At operation 504, the conversion component 116 retrieves file content associated with the file. In some cases, to retrieve the file content, the conversion component 116 retrieves the file from a file system. In some cases, to retrieve the file content, the conversion component 116 downloads the file from a network location. In some cases, to retrieve the file content, the conversion component 116 accesses the file via an API. An example of file content data 516 associated with a file is depicted in FIG. 5. As depicted in FIG. 5, the file content data 516 includes firewall log data.

At operation 506, the conversion component 116 determines a content summary of the file content. In some cases, the content summary is a text-based summary of the file content. In some cases, the content summary is a machine-readable summary of the file content. In some cases, to determine the content summary, the conversion component 116 provides the file content as an input to a machine learning model, such as the machine learning model 518. In some cases, the machine learning model 518 includes a generative machine learning model, a transformer-based machine learning model, an attention-based machine learning model, and/or the like. An example of a content summary 520 determined based on processing the file content data 516 associated with a file using a machine learning model 518 is depicted in FIG. 5.

At operation 508, the conversion component 116 determines a converted communication that includes the content summary. In some cases, the converted communication is a communication that is compatible with one or more requirements of a destination communication platform. In some cases, the converted communication may be transmitted to and/or displayed using the destination communication platform.

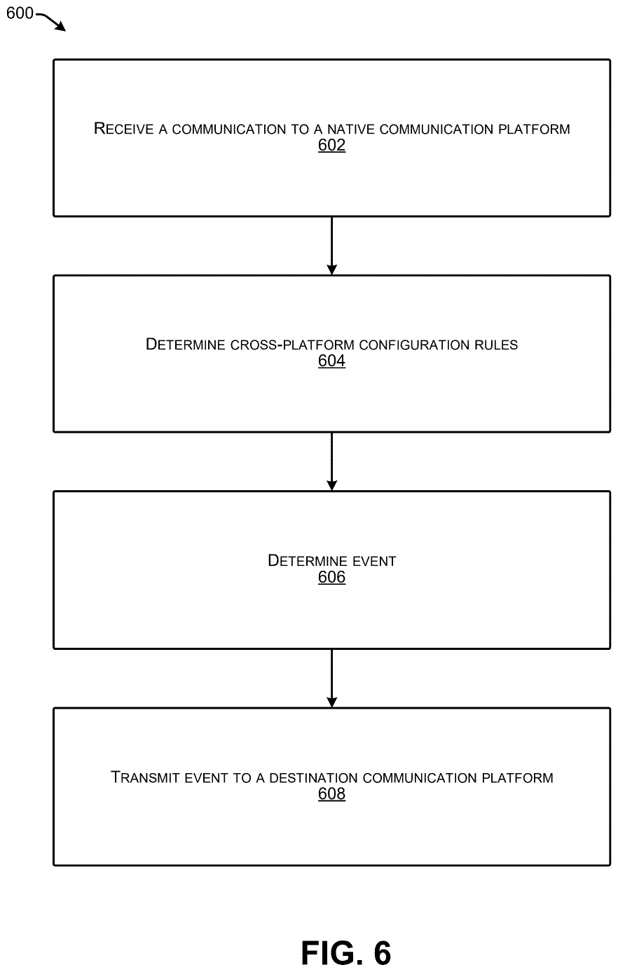

FIG. 6 is a flowchart diagram of an example process 600 for transmitting a communication from a native communication platform of a SOAR system to an external communication platform.

At operation 602, the cross-platform communication system 122 receives a communication directed to a communication interface of the native communication platform 120. The communication may include one or more of: text, images, videos, audio files, emojis, reactions, mentions, links, attachments, and/or the like. The communication may be from a user, a group of users, and/or a bot. The communication interface may be associated with a security incident, a vulnerability, a threat, a task, a project, and/or the like.

At operation 604, the cross-platform communication system 122 determines a set of cross-platform conversion rules for converting communications from the native communication platform 120 to the external communication platform 136. The cross-platform conversion rules may include rules for converting one or more of: message formats, file types, user mentions, timestamps, message reactions, and/or hyperlinks. The cross-platform conversion rules may be stored in a database, a configuration file, and/or the like. The cross-platform conversion rules may be specific to a pair of communication platforms, a group of communication platforms, and/or the like.

At operation 606, the cross-platform communication system 122 determines converted communication data based on the retrieved cross-platform conversion rules and the received communication. The converted communication data may include one or more of: text, images, videos, audio files, emojis, reactions, mentions, links, attachments, and/or the like. The converted communication data may be formatted according to the requirements of the external communication platform 136.

At operation 608, the cross-platform communication system 122 transmits the converted communication data to the external communication platform 136. The converted communication data may be transmitted via one or more communication protocols, such as HTTP, WebSockets, XMPP, MQTT, and/or the like. The converted communication data may be transmitted to a specific user, a group of users, a channel, and/or the like. The converted communication data may be displayed in the external communication platform 136 along with additional information, such as a timestamp, a user identifier, and/or the like.

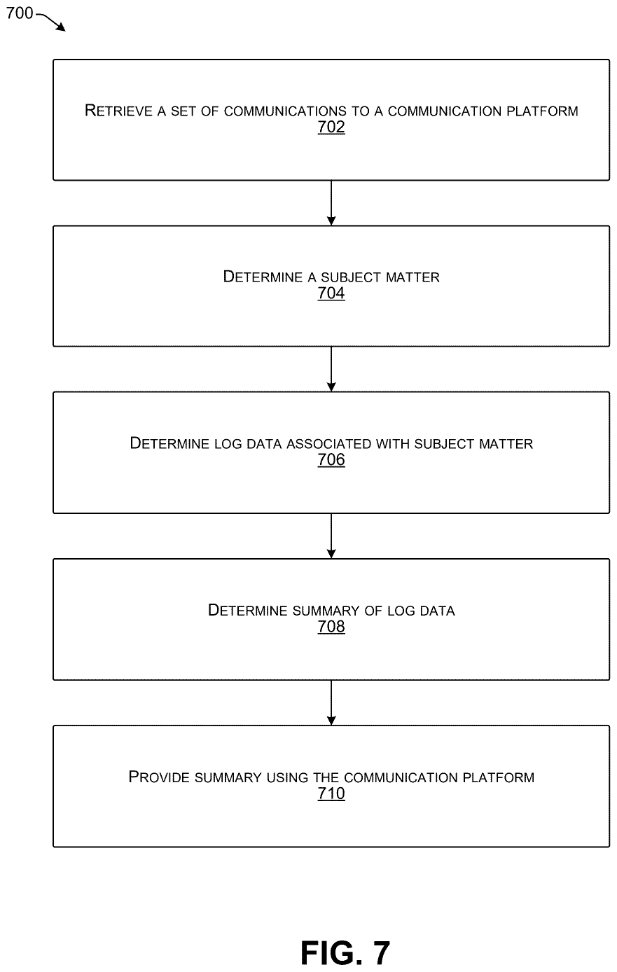

FIG. 7 is a flowchart diagram of an example process 700 for predictively generating a communication to a native communication platform of a SOAR system.

At operation 702, the cross-platform communication system 122 retrieves a set of communications to a communication interface of the native communication platform 120. The set of communications may include one or more of: messages, reactions, mentions, attachments, and/or the like. The communication interface may be associated with a security incident, a vulnerability, a threat, a task, a project, and/or the like.

At operation 704, the cross-platform communication system 122 determines a subject matter associated with the set of communications. The subject matter may be a topic, a theme, a concept, an entity, and/or the like. The subject matter may be determined using one or more machine learning models, such as natural language processing (NLP) models, topic modeling models, and/or the like.

At operation 706, the cross-platform communication system 122 determines log data associated with the subject matter. The log data may be retrieved from one or more log databases, log files, and/or the like. The log data may include one or more of: security logs, system logs, application logs, network logs, and/or the like.

At operation 708, the cross-platform communication system 122 determines a summary of the log data. The summary may be a text-based summary, a visualization, a table, and/or the like. The summary may be generated using one or more machine learning models, such as time series forecasting models, anomaly detection models, and/or the like.

At operation 710, the cross-platform communication system 122 provides the summary using the communication platform. The summary may be posted to the communication interface as a message, a reply, a comment, and/or the like. The summary may be provided to a specific user, a group of users, and/or the like. The summary may be accompanied by additional information, such as a timestamp, a user identifier, and/or the like.

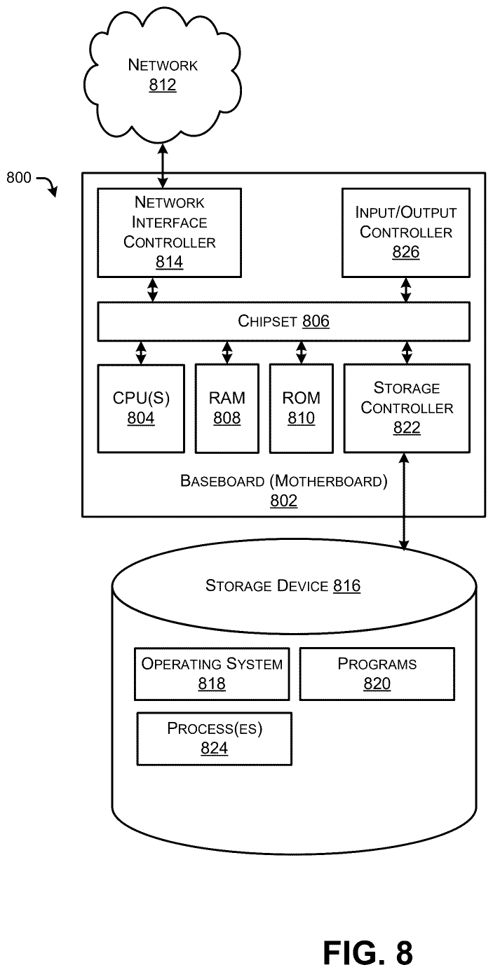

FIG. 8 shows an example computer architecture for a computer 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computer 800 may, in some examples, correspond to a network node (e.g., the 8) described herein.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a random-access memory (RAM) 808, used as the main memory in the computer 800. The chipset 806 can further provide an interface to a computer-readable storage medium such as a read-only memory (ROM) 810 or non-volatile RAM (NVRAM) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 812. The chipset 806 can include functionality for providing network connectivity through a network interface controller (NIC) 814, such as a gigabit Ethernet adapter. The NIC 814 is capable of connecting the computer 800 to other computing devices over the network 812. It should be appreciated that multiple NICs 814 can be present in the computer 800, connecting the computer 800 to other types of networks and remote computer systems. In some instances, the NICs 814 may include at least on ingress port and/or at least one egress port.

The computer 800 can be connected to a storage device 816 that provides non-volatile storage for the computer. The storage device 816 can store an operating system 818, programs 820, and data, which have been described in greater detail herein. The storage device 816 can be connected to the computer 800 through a storage controller 822 connected to the chipset 806. The storage device 816 can consist of one or more physical storage units. The storage device 816 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 800 can store data on the storage device 816 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 816 is characterized as primary or secondary storage, and the like.

For example, the computer 800 can store information to the storage device 816 by issuing instructions through the storage controller 822 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 816 by detecting the physical states or characteristics of one or more particular locations within the physical storage units.

In addition to the storage device 816 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by any network node described herein may be supported by one or more devices similar to computer 800. Stated otherwise, some or all of the operations performed by a network node may be performed by one or more computers 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 816 can store an operating system 818 utilized to control the operation of the computer 800. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 816 can store other system or application programs and data utilized by the computer 800.

In one embodiment, the storage device 816 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7. The computer 800 can also include computer-readable storage media having instructions stored thereupon for performing any of the other computer-implemented operations described herein.

As illustrated in FIG. 8, the storage device 816 stores the programs 820, which may include one or more processes 824, as well as YY. The processes 824 may include instructions that, when executed by the CPUs 804, cause the computer 800 and/or the CPUs 804 to perform one or more operations.

The computer 800 can also include at least one input/output controller 826 for receiving and processing input from a number of input devices, such as a keyboard, a mouse, a touchpad, a touch screen, an electronic stylus, or other type of input device. Similarly, an input/output controller 826 can provide output to a display, such as a computer monitor, a flat-panel display, a digital projector, a printer, or other type of output device. It will be appreciated that the computer 800 might not include all of the components shown in FIG. 8, can include other components that are not explicitly shown in FIG. 8, or might utilize an architecture completely different than that shown in FIG. 8.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving a first communication provided by a first user profile to a communication interface of a first communication platform, the first communication platform being native to a Security Orchestration, Automation and Response (SOAR) system;
determining that the communication interface is associated with a plurality of users comprising the first user profile and a second user profile;
determining that the second user profile is associated with a third user profile, the third user profile being associated with a second communication platform;
retrieving one or more cross-platform conversion rules associated with the second communication platform;
determining, based on the first communication and the one or more cross-platform conversion rules, a converted communication; and
transmitting the converted communication to a system, wherein the system is configured to, based on receiving the converted communication, display a second communication to the third user profile using the second communication platform.

2. The method of claim 1, further comprising:
providing a set of communications posted to the communication interface to a first machine learning model;
receiving, from the first machine learning model, an entity associated with the set of communications, the entity being associated with at least one of a software application or a computing device;
providing incident management data associated with the entity to a second machine learning model; and
receiving, from the second machine learning model, a description of the incident management data.

3. The method of claim 2, further comprising providing a third communication determined based on the description using the communication interface.

4. The method of claim 2, further comprising determining the converted communication based on the description.

5. The method of claim 1, wherein:
the one or more cross-platform conversion rules comprise a first rule requiring reporting of reaction data for messages posted to the communication interface; and
determining the converted communication comprises, based on the first rule:
determining that the first communication comprises a first reaction to a first message posted on the communication interface; and
determining the converted communication based on the first reaction and the first message.

6. The method of claim 1, wherein:
the one or more cross-platform conversion rules comprise a first rule associated with summary data associated with documents linked to via posts in the communication interface; and
determining the converted communication comprises, based on the first rule:
determining that the first communication comprises a first link to a first document;
determining, based on content data associated with the first document and using a machine learning model, a summary associated with the first document; and
determining the converted communication based on the summary.

7. The method of claim 1, wherein:
the one or more cross-platform conversion rules comprise a first rule associated with invite data associated with events posted to the communication interface; and
determining the converted communication comprises, based on the first rule:
determining that the first communication comprises a first invite to a first event, the first event being associated with a first calendar management application that is native to the SOAR system; and
determining the converted communication based on the first invite.

8. The method of claim 7, wherein the system is configured to, based on receiving the converted communication, generating a second event, the second event being associated with a second calendar management application.

9. The method of claim 1, further comprising:
providing a set of communications posted to the communication interface to a machine learning model;
receiving, from the machine learning model, a description associated with the set of communications; and
providing a third communication determined based on the description using the communication interface.

10. The method of claim 9, further comprising:
receiving a message by the first user profile, the message being in response to the third communication;
based on receiving the message, providing the message to the machine learning model;
receiving, from the machine learning model, a response to the message; and
providing a fourth communication determined based on the response using the communication interface.

11. A system comprising:
one or more processors; and
one or more non-transitory computer-readable media storing computer-executable instructions that, when executed, cause the system to perform operations comprising:
receiving a first communication provided by a first user profile to a communication interface of a first communication platform, the first communication platform being native to a Security Orchestration, Automation and Response (SOAR) system;
determining that the communication interface is associated with a plurality of users comprising the first user profile and a second user profile;
determining that the second user profile is associated with a third user profile, the third user profile being associated with a second communication platform;
retrieving one or more cross-platform conversion rules associated with the second communication platform;
determining, based on the first communication and the one or more cross-platform conversion rules, a converted communication; and
transmitting the converted communication to a second system, wherein the second system is configured to, based on receiving the converted communication, display a second communication to the third user profile using the second communication platform.

12. The system of claim 11, the operations further comprising:
providing a set of communications posted to the communication interface to a first machine learning model;
receiving, from the first machine learning model, an entity associated with the set of communications, the entity being associated with at least one of a software application or a computing device;
providing incident management data associated with the entity to a second machine learning model; and
receiving, from the second machine learning model, a description of the incident management data.

13. The system of claim 12, the operations further comprising providing a third communication determined based on the description using the communication interface.

14. The system of claim 13, the operations further comprising determining the converted communication based on the description.

15. The system of claim 11, wherein:
the one or more cross-platform conversion rules comprise a first rule requiring reporting of reaction data for messages posted to the communication interface; and
determining the converted communication comprises, based on the first rule:
determining that the first communication comprises a first reaction to a first message posted on the communication interface; and
determining the converted communication based on the first reaction and the first message.

16. The system of claim 11, wherein:
the one or more cross-platform conversion rules comprise a first rule associated with summary data associated with documents linked to via posts in the communication interface; and
determining the converted communication comprises, based on the first rule:
determining that the first communication comprises a first link to a first document;
determining, based on content data associated with the first document and using a machine learning model, a summary associated with the first document; and
determining the converted communication based on the summary.

17. The system of claim 11, wherein:
the one or more cross-platform conversion rules comprise a first rule associated with invite data associated with events posted to the communication interface; and
determining the converted communication comprises, based on the first rule:
determining that the first communication comprises a first invite to a first event, the first event being associated with a first calendar management application that is native to the SOAR system; and
determining the converted communication based on the first invite.

18. One or more non-transitory computer-readable media storing instructions executable by one or more processors, wherein the instructions, when executed, cause the one or more processors to perform operations comprising:
receiving a first communication provided by a first user profile to a communication interface of a first communication platform, the first communication platform being native to a Security Orchestration, Automation and Response (SOAR) system;
determining that the communication interface is associated with a plurality of users comprising the first user profile and a second user profile;
determining that the second user profile is associated with a third user profile, the third user profile being associated with a second communication platform;
retrieving one or more cross-platform conversion rules associated with the second communication platform;
determining, based on the first communication and the one or more cross-platform conversion rules, a converted communication; and
transmitting the converted communication to a system, wherein the system is configured to, based on receiving the converted communication, display a second communication to the third user profile using the second communication platform.

19. The one or more non-transitory computer-readable media of claim 18, further comprising:
providing a set of communications posted to the communication interface to a first machine learning model;
receiving, from the first machine learning model, an entity associated with the set of communications, the entity being associated with at least one of a software application or a computing device;
providing incident management data associated with the entity to a second machine learning model; and
receiving, from the second machine learning model, a description of the incident management data.

20. The one or more non-transitory computer-readable media of claim 19, the operations further comprising providing a third communication determined based on the description using the communication interface.
